(19) United States
(12) Patent Application Publication
(10) Pub. No.: US 2026/0053693 A1
(43) Pub. Date: Feb. 26, 2026

(54) ADJUSTABLE-LENGTH LIMB-COMPRESSION DEVICE

(71) Applicant: MerchSource, LLC, Irvine, CA (US)

(72) Inventors: Mark Filipek, Irvine, CA (US); Peter Keun-Hyun YOO, Irvine, CA (US)

(73) Assignee: MerchSource, LLC, Irvine, CA (US)

(21) Appl. No.: 18/810,983

(22) Filed: Aug. 21, 2024

(51) Int. Cl. A61H 9/00

(52) U.S. Cl. CPC A61H 9/0078; A61H 2201/0103; A61H 2201/165; A61H 2205/06; A61H 2205/10

(57) ABSTRACT

A limb compression device, such as for compressing at least part of an arm or leg, has an adjustable length, with part of the device configured to fold over to reduce the total length of the boot. The compression device may have multiple bladders, for selectively providing compression to different parts of a user's limb. There may be a gap between adjacent of the bladders, allowing folding of an end part of the device over a central part, to selectively reduce length of the limb compression device. The adjustable length of the compression device may facilitate its versatility in accommodating users of various sizes (leg lengths), and may provide an advantage to retailers (for example) in reducing the need to maintain an inventory of different sizes.

### FIELD

The disclosure in the field of limb-compression devices, and methods for operating and/or configuring such devices.

### BACKGROUND

Current leg air-compression sleeves are generally fixed in length. Some companies offer the same model in different lengths, in order to accommodate the needs of users having different heights and/or different leg lengths.

### SUMMARY

A limb-compression device has a foldable portion that can be folded over to reduce the length of the device. The foldable portion may include an air bladder.

According to an aspect of the disclosure, a limb-compression device includes: a shell for receiving a limb of a user therein; and multiple compression bladders within the shell, spaced along a length of the shell; wherein the shell includes a foldable section between an adjacent pair of the bladders, to allow folding of the shell to reduce a length of the limb-compression device to less than the length of the shell.

According to an embodiment of any paragraph(s) of this summary, the limb-compression device is a leg compression device for compressing at least part of a leg of the user.

According to an embodiment of any paragraph(s) of this summary, the at least part of a leg includes the lower leg, from at least knee to ankle.

According to an embodiment of any paragraph(s) of this summary, the at least part of a leg includes the upper leg, from at least thigh to knee.

According to an embodiment of any paragraph(s) of this summary, the at least part of a leg includes the full leg, from at least thigh to ankle.

According to an embodiment of any paragraph(s) of this summary, the at least part of a leg includes a foot of the user.

According to an embodiment of any paragraph(s) of this summary, the limb-compression device is a leg compression device for compressing at least part of an arm of the user.

According to an embodiment of any paragraph(s) of this summary, the at least part of an arm of the user includes an upper arm of the user, from shoulder to elbow.

According to an embodiment of any paragraph(s) of this summary, the at least part of an arm of the user includes a lower arm of the user, from at least elbow to wrist.

According to an embodiment of any paragraph(s) of this summary, the at least part of an arm of the user includes a lower arm of the user, from at least elbow to hand.

According to an embodiment of any paragraph(s) of this summary, the at least part of an arm of the user includes a full arm of the user, from at least shoulder to wrist.

According to an embodiment of any paragraph(s) of this summary, the at least part of an arm of the user includes a full arm of the user, from at least shoulder to hand.

According to an embodiment of any paragraph(s) of this summary, the foldable section is at a gap between the adjacent pair of the bladders.

According to an embodiment of any paragraph(s) of this summary, folding the shell at the foldable section overlaps bladders of the adjacent pair of the bladders.

According to an embodiment of any paragraph(s) of this summary, folding the shell at the foldable section reduces the length of the limb-compression device by at least 10%.

According to an embodiment of any paragraph(s) of this summary, the multiple bladders include at least three bladders.

According to an embodiment of any paragraph(s) of this summary, the multiple bladders include at least five bladders.

According to an embodiment of any paragraph(s) of this summary, there is some overlap of other adjacent pairs of the bladders, other than the adjacent pair of bladders bordering the foldable section.

According to an embodiment of any paragraph(s) of this summary, the shell includes an upper leg end and a lower leg end, with the foldable section closer to the upper leg end than the lower leg end.

According to an embodiment of any paragraph(s) of this summary, the shell at the lower leg end includes a foot covering for covering a foot of the user.

According to an embodiment of any paragraph(s) of this summary, the upper leg end is a thigh end.

According to an embodiment of any paragraph(s) of this summary, the shell has a zipper closure.

According to an embodiment of any paragraph(s) of this summary, the limb-compression device is in combination with a control unit that controls inflation and deflation of the bladders.

According to an embodiment of any paragraph(s) of this summary, the control unit is configured to operate the limb-compression device differently, depending on whether the shell is folded at the foldable section.

According to an embodiment of any paragraph(s) of this summary, the control unit receives input from the user as to whether the shell is folded at the foldable section.

According to an embodiment of any paragraph(s) of this summary, the control unit automatically detects whether the shell is folded at the foldable section.

According to an embodiment of any paragraph(s) of this summary, the control unit includes a compressor for supplying compressed air to the bladders.

According to an embodiment of any paragraph(s) of this summary, the compressor is a battery-powered compressor.

According to an embodiment of any paragraph(s) of this summary, a leg-compression system further includes: an additional leg-compression device; and a manifold couplable to the control unit and the leg-compression devices.

According to another aspect, a method of configuring a limb-compression device includes: providing the limb-compression device, the limb-compression device including: a shell for receiving a leg of a user therein; and multiple compression bladders within the shell, spaced along a length of the shell; wherein the shell includes a foldable section between an adjacent pair of the bladders, to allow folding of the shell to reduce a length of the limb-compression device to less than the length of the shell; and selecting the length of the limb-compression device based on limb length of the user, if necessary, folding the shell at the foldable section to reduce the length of the limb-compression device.

According to an embodiment of any paragraph(s) of this summary, the method further includes configuring a control unit that is coupled to the limb-compression device, based on whether the shell is folded at the foldable section.

According to an embodiment of any paragraph(s) of this summary, the control unit is configured automatically based on whether the shell is folded at the foldable section.

According to yet another embodiment, a control unit for controlling inflation and deflation of bladders in a shell of a limb-compression device, includes: circuitry configured to operate the limb-compression device differently, depending on whether the shell is folded at a foldable section.

While a number of features are described herein with respect to embodiments of the disclosure; features described with respect to a given embodiment also may be employed in connection with other embodiments. The following description and the annexed drawings set forth certain illustrative embodiments of the disclosure. These embodiments are indicative, however, of but a few of the various ways in which the principles of the disclosure may be employed. Other objects, advantages, and novel features according to aspects of the disclosure will become apparent from the following detailed description when considered in conjunction with the drawings.

### BRIEF DESCRIPTION OF THE DRAWINGS

The annexed drawings, which are not necessarily to scale, show various aspects of the disclosure.

FIG. 1 is a schematic view of a leg-compression system according to an embodiment.

FIG. 2 is an oblique view of a leg-compression boot device of the system of FIG. 1.

FIG. 3 is a side view of the leg-compression device of FIG. 2.

FIG. 4 is an oblique view of the leg-compression device of FIG. 2, in a folded configuration.

FIG. 5 is a block diagram of a system for moving air into and out of bladders, as a part of the leg-compression system of FIG. 1.

FIG. 6 is a block diagram illustrating hardware that includes part of the control unit of the leg-compression system of FIG. 1.

FIG. 7 is a high-level flowchart of a method, according to an embodiment.

FIG. 8 is a side view of the limb-compression device with multiple folding sections, according to another embodiment.

FIG. 9 is a side view of a lower-leg-compression device, according to yet another embodiment.

FIG. 10 is a side view of an arm-compression device, according to still another embodiment.

### DETAILED DESCRIPTION

A limb compression device, such as for compressing at least part of an arm or leg, has an adjustable length, with part of the device configured to fold over to reduce the total length of the boot. The compression device may have multiple bladders, for selectively providing compression to different parts of a user's limb. There may be a gap between adjacent of the bladders, allowing folding of an end part of the device over a central part, to selectively reduce length of the limb compression device. The adjustable length of the compression device may facilitate its versatility in accommodating users of various sizes (leg lengths), and may provide an advantage to retailers (for example) in reducing the need to maintain an inventory of different sizes.

In the following description various limb-compression devices are shown. The most-discussed embodiment is a leg-compression device for compression at least part of a user's leg, such as the full leg (at least from thigh to ankle) or only a lower leg (from knee to at least ankle). However, the term “limb-compression device” also includes arm-compression devices for compressing all or part of a user's arm.

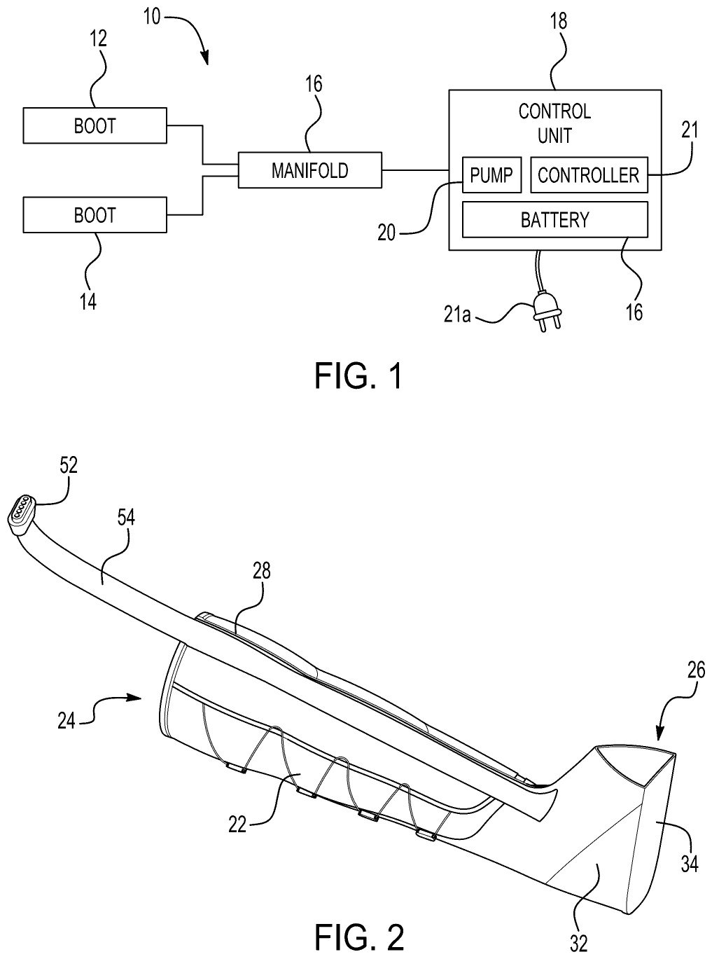

FIG. 1 shows a leg-compression system 10 that includes a pair of leg-compression devices 12 and 14, which may be leg-compression boots for the right and left legs of a user, a manifold 16, and a control unit 18, which includes a compressor or pump 20. The pump 20 provides compressed air to the manifold 16, which in turn routes the compressed air to various parts of the compression boots 12 and 14. The manifold 16 may include a plug, to block one of its output ports when only a single of the leg-compression devices 12 and 14 is used. The control unit 18 may include a controller 21 that controls operation of the pump 20, and how the air is directed to various parts of the boots 12 and 14. The control unit 18 may have a plug 21a for receiving power from an electrical outlet, and/or may have a battery 21b for providing self-contained power for the compressor (pump) 20 and other components.

FIG. 2 shows details of the compression boot 12. The compression boot 12 has a shell 22, with an upper leg end 24, and a lower leg end 26. The shell 22 may be made of a suitable flexible material, such as vinyl or another suitable plastic. A zipper 28 on one side of the shell 22 may run the length of the shell 22. The zipper 28 may be unzipped to facilitate allowing the leg of a user to be inserted into or withdrawn from the shell 22. The zipper 28 may be zipped up and locked with the user's leg in the sleeve 22 for operation of the compression device 12. The locking of the zipper 28 may prevent the shell 22 from unzipping and opening up when air is pumped into the compression boot 12.

In the illustrated embodiment the compression boot 12 has a foot-receiving portion 32, with a sole panel 34 that overlies the bottom of a user's foot. Alternatively the boot may be configured to omit the foot-receiving portion 32, for example extending only from thigh to ankle of a user.

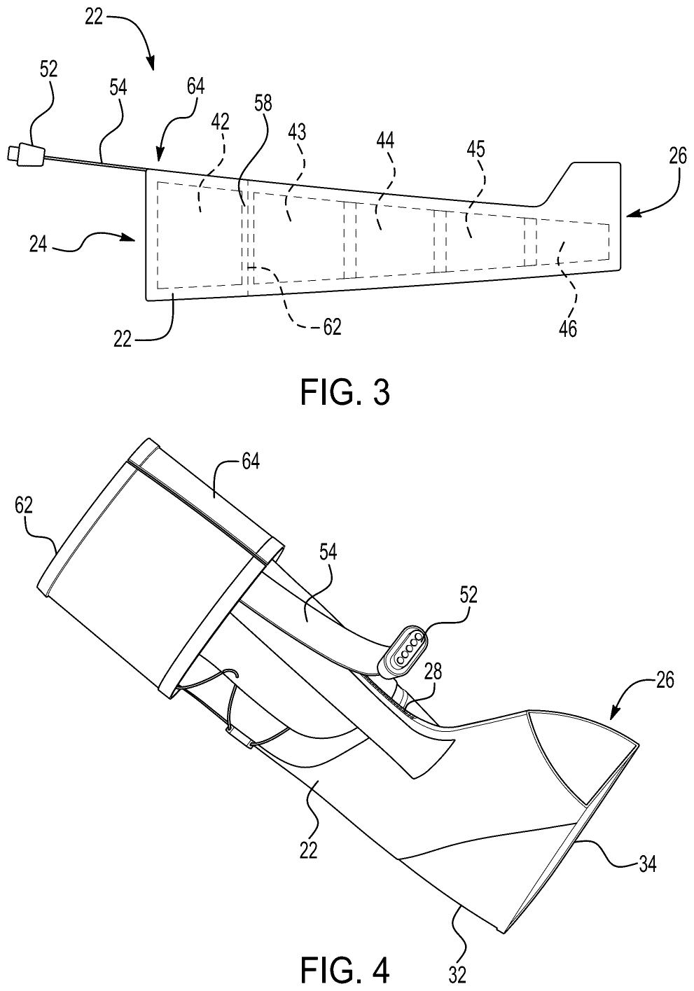

Referring in addition to FIG. 3, the boot 12 has within the shell 22 a series of bladders 42, 43, 44, 45, and 46, arranged along the length of the boot 12, from the upper leg end 24 (where the bladder 42 is located) to the lower leg end 26 (where the bladder 46 is located). The bladders 42-46 may be pressurized and depressurized, individually or in combination, by introduction and removal of compressed air. Thus compression of different parts of the user's leg may be accomplished using the boot 12.

A connector 52 may provide a connection to the manifold 16 (FIG. 1). the connector 52 may be made of a suitable plastic, for example. Separate channels 54 run from the connector 52 to the bladders 42-46 to direct pressurized air to and from the bladders 42-46. The channels 54 may be located side by side in a suitable flexible material, such as rubber or a suitable plastic. The flat ribbon of material containing the channels 54 may be surrounded by a suitable fabric, to help protect the channeled material from damage.

Adjoining of the bladders 43-46 may slightly overlap one another. This facilitates providing desired compression to all parts of the leg of a user, without having areas of the leg that are covered by the shell 22 that are not subject to potential compression.

Yet there is a gap 58 between the bladders 42 and 43 that are closest to the upper leg end 24. The gap 58 is located at a fold location 62, defining a foldable section 64 at the upper leg end 24 of the boot 12. The foldable section 64 may be folded over onto a lower part of the shell 22, to reduce the length of the boot 12. The reduction in length may be at least 10%, or in the range of 10% to 60%. This allows the boot 12 to be used with users of different sizes (different leg lengths).

The bladders 42-46 all may cover the same or approximately the same length along the leg-compression device (boot) 12. Alternatively they may cover non-uniform lengths. For example, the bladder 42 may cover less length, such that the folded section 54 is a smaller section of the shell 22 than the portions of the shell 22 enclosing the other bladders. In addition the bladder 46 at the lower leg end 26 may be shorter than the middle bladders 43-45, in order to facilitate manufacture.

The illustrated embodiment has five of the bladders 42-46. However it will be appreciated that alternative arrangements may have a different number (greater or lesser) of bladders.

FIG. 4 shows the boot 12 in a folded-over configuration, with the foldable section 64 folded over and overlapping other parts of the shell 22, contrasting with the unfolded configuration shown in FIG. 2. With the boot 12 in the folded-over configuration, it is now suitable for use by a user with a shorter leg, a leg length that might be too short for use of the boot 12 in the unfolded configuration of FIG. 2. This is advantageous for multiple reasons. First, it increases the versatility of the boot 12, enabling it to be used by users having markedly different leg lengths. These users may be family members (such as spouses) or friends, or even casual acquaintances interested in trying the leg-compression boot 12.

In addition, the variable-length boot 12 is advantageous to wholesalers and retailers who may be able to produce and/or keep in inventory fewer boot sizes (or only a single boot size) to accommodate users having a (large) range of leg lengths, larger than could be accommodated by a single (unfoldable) sleeve configuration.

When the boot 12 is in the folded configuration, it may be advantageous to disable pressurization of the bladder 42. This may be accomplished manually by the user, such as by the user making a selection on the control unit 18. The manual indication may be made by a simple push of a configuration button on the control unit 18 (for example).

Alternatively the system 10 (FIG. 1) may be configured to allow for automatic detection of the folded configuration of the boot 12. For example, folding the top section of the boot might activate a magnetic switch that aids in maintaining the folded-over configuration, and that also is coupled to the control unit 18, providing an indication to the control unit 18 of the folded-over configuration. As another example, a mechanical switch may be used, for example by engagement of a mechanical fastener, such as a button or snap, when a section of the boot is folded.

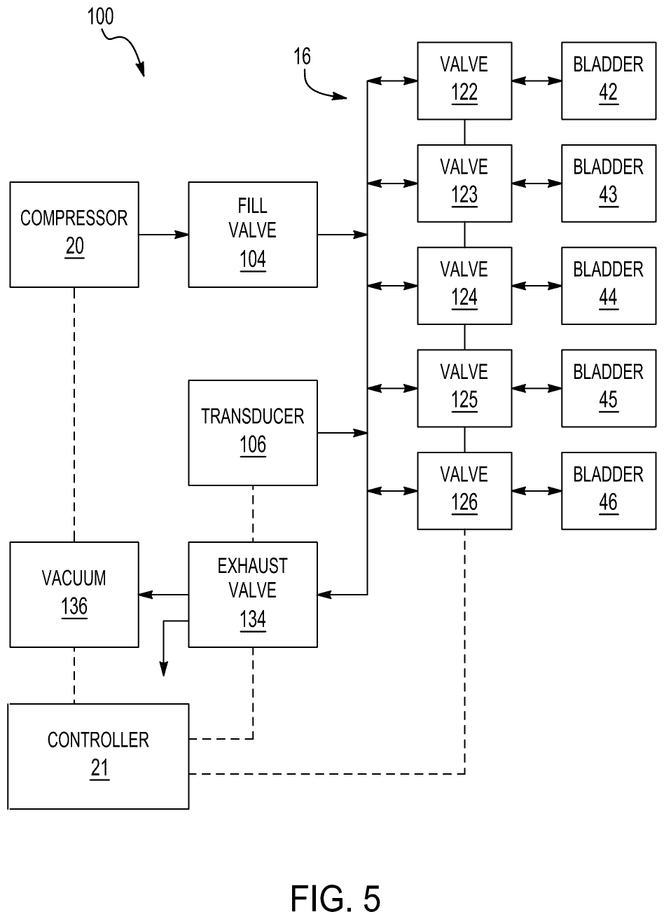

FIG. 5 shows a block diagram of a system 100 for moving air into and out of the bladders 42-46. The control unit 18 may include the compressor 20, which selectively provides compressed air to the manifold 16, through a fill valve 104. A transducer 106 may monitor pressure in the manifold 16. Flow from the manifold 16 to the bladders 42-46 may be controlled by a series of valves 122, 123, 124, 125, and 126, corresponding to respective of the bladders 42-46. An exhaust valve 134 may allow deflation of one or more of the bladders 42-46, with air exiting the bladders 42-46 by action of a vacuum source 136, or merely dumped to an external atmosphere. The controller 21 may be operably coupled to the compressor 20, fill valve 104, the transducer 106, the valves 122-126, the exhaust valve 134, and the vacuum source 136, to receive data and control operation of various parts of the system 100.

It should be understood that FIG. 5 shows a basic system for moving air. Many alternatives and more complicated arrangements are possible. For instance, there may be additional transducers, such as flow sensors and/or pressure sensors corresponding to the individual bladders. As another possible alternative, there may be individual flow paths corresponding to each of the bladders 42-46, which would allow filling of some of the bladders 42-46 while deflating other of the bladders 42-46.

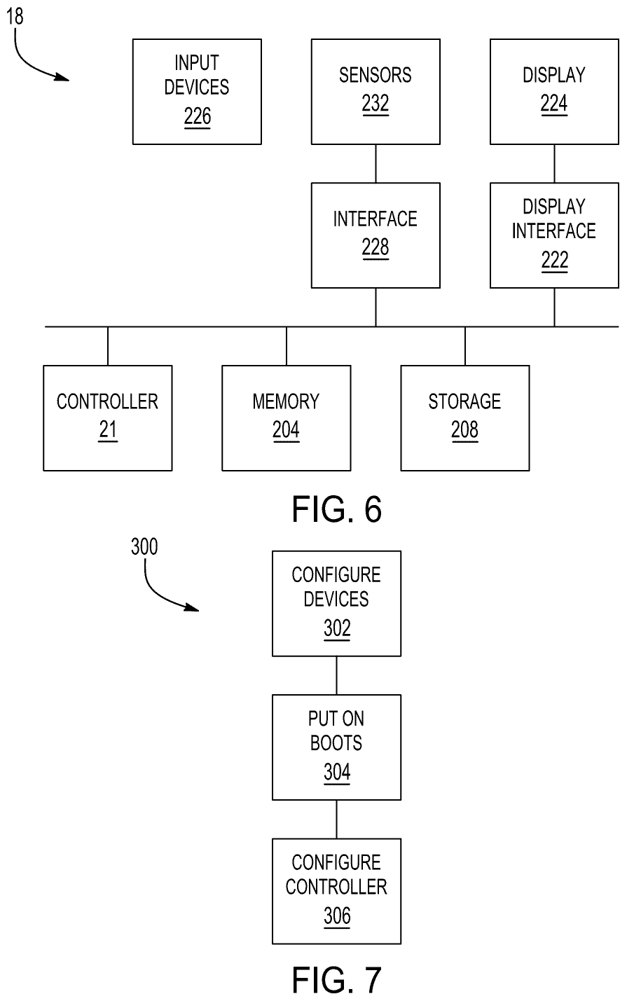

FIG. 6 shows a schematic view of parts of the control unit 18. The control unit 18 includes the controller 21 and a memory 204. The controller 21 can include any of a variety of various processors including dual microprocessor and other multi-processor architectures. The memory 204 can include volatile memory or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM). Storage 208 may be operably connected to controller 21 via a bus 210. The storage 208 can include, but is not limited to, devices like a magnetic disk drive, a solid-state disk drive, a flash memory card, or a memory stick. The memory 204 can store processes or data.

The bus 210 can be a single internal bus interconnect architecture or other bus or mesh architectures. While a single bus is illustrated, it is to be appreciated that the system (the control unit 18) may communicate with various devices, logics, and peripherals using other buses that are not illustrated (e.g., PCIE, SATA, Infiniband, 1394, USB, Ethernet). The bus 210 can be of a variety of types including, but not limited to, a memory bus or memory controller, a peripheral bus or external bus, a crossbar switch, or a local bus. The local bus can be of varieties including, but not limited to, an industrial standard architecture (ISA) bus, a microchannel architecture (MCA) bus, an extended ISA (EISA) bus, a peripheral component interconnect (PCI) bus, a universal serial (USB) bus, and a small computer systems interface (SCSI) bus.

A display interface 222 may be coupled to the bus 210, and may provide information to be displayed on a display 224 that may be consulted by the user. For instance, the display 224 may show information on operation such as the mode of operation (for example, pulse, gradual, sequenced, targeted-pulse compression in selected zones, or manual selection of compression in individual zones), pressure settings, or a timer, to provide a few possible non-limiting examples. The user may have access to input devices 226, such as touch pads or buttons (or other types of input devices), to make various selections for operation. The input devices 226 may be connected to the bus 210 by an interface 228.

The interface 228 also may couple one or more sensors 232 to the bus 210. The sensors 232 may communicate usage data, such as pressure data, flow data, and/or usage history, to give a few non-limiting examples.

FIG. 7 is a flow chart of a method 300 of operating the leg-compression system 10 (FIG. 1). In step 302 the user configures the leg-compression device(s) (boot(s)) 12 and 14 (FIG. 1) as necessary. The leg-compression devices may be placed in the folded-over configuration, if necessary in order to provide a proper fit or preferred configuration for the user.

In step 304 the user puts the boots 12 and 14 (FIG. 1) on his or her legs. In step 306 the controller is configured for the length of the boots 12 and 14, either full length (not folded) or shorter length (folded). This configuring may be done by the user, or alternatively the system may automatically detect the folded-over configuration, either prior to or upon commencement of compression operation.

The leg-compression devices 12 and 14 (FIG. 1) described above may have the advantage of fitting a larger range of users. This may be advantageous for related users (such as spouses) that have different leg lengths, in that they may be able to share a single set of leg-compression devices. In addition, the flexibility in sizing and fit may benefit manufacturers and retailers, who may have to maintain a smaller inventory of devices, or even may get by with offering a single size.

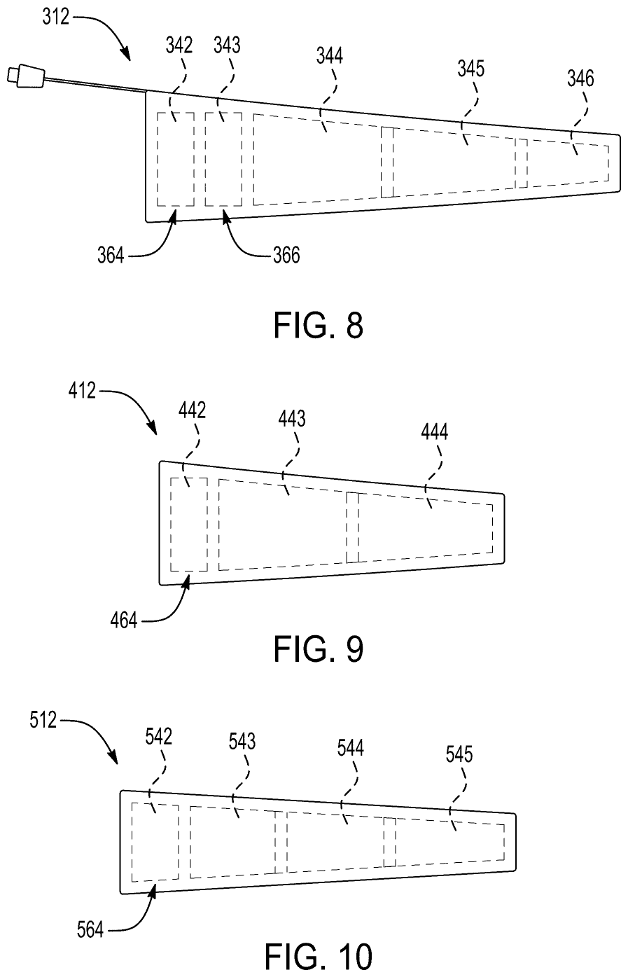

Many alternative configurations are possible. For example it may be possible to have devices with multiple foldable sections, able to produce three (or more) possible lengths for a single device. An example of such a device is the limb-compression device 312 shown in FIG. 8, which has bladders 342, 343, 344, 345, and 346, which may be selectively filled to cause compression to different parts of the user's limb. The bladders 342 and 343 are in respective foldable sections 364 and 366, which can be folded individually or together to change the length of the device 312. The multiple foldable sections 364 and 366 may be on the same side of the device 312, as is illustrated.

Alternatively multiple foldable sections may be located on opposite ends of a compression device. Other features and details of the device 312 may be similar to those of the device 12 (FIG. 1).

FIG. 9 shows another embodiment, a leg-compression device 412 configured to engage only a lower leg of a user, such as from the user's knee to ankle (and perhaps foot). The device 412 includes three bladders 442, 443, and 444, one of which (the bladder 442) is in a foldable section 464. This is only an example embodiment, and the number and/or configuration of the bladders and other components may be varied. Other features and details of the device 412 may be similar to those of the device 12 (FIG. 1).

FIG. 10 shows a further embodiment, an arm-compression device 512 having bladders 542, 543, 544, and 545, for compressing different parts of a user's arm (including perhaps the hand of the user). The bladder 542 is in a foldable section 564 that may be folded over to reduce the length of the arm-compression device 512. Other features and/or variations for the device 512 may be similar to those described above for other embodiments.

Although the disclosure has been shown and described with respect to a certain embodiment or embodiments, equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the disclosure. In addition, while a particular feature of the disclosure may have been described above with respect to only one or more of several illustrated embodiments, such feature may be combined with one or more other features of the other embodiments, as may be desired and advantageous for any given or particular application.

What is claimed is:

1. A limb-compression device comprising:
a shell for receiving a limb of a user therein; and
multiple compression bladders within the shell, spaced along a length of the shell;
wherein the shell includes a foldable section between an adjacent pair of the bladders, to allow folding of the shell to reduce a length of the limb-compression device to less than the length of the shell.

2. The limb-compression device of claim 1, wherein the foldable section is at a gap between the adjacent pair of the bladders.

3. The limb-compression device of claim 1, wherein folding the shell at the foldable section overlaps bladders of the adjacent pair of the bladders.

4. The limb-compression device of claim 1, wherein folding the shell at the foldable section reduces the length of the leg-compression device by at least 10%.

5. The limb-compression device of claim 1, wherein there is some overlap of other adjacent pairs of the bladders that are other than the adjacent pair of bladders bordering the foldable section.

6. The limb-compression device of claim 1,
wherein the limb-compression device is a leg-compression device for receiving a leg of the user; and
wherein the shell includes an upper leg end and a lower leg end, with the foldable section closer to the upper leg end than the lower leg end.

7. The limb-compression device of claim 6, wherein the shell at the lower leg end includes a foot covering for covering a foot of the user.

8. The limb-compression device of claim 1, wherein the limb-compression device is an arm-compression device for receiving an arm of the user.

9. The limb-compression device of claim 1, wherein the shell has a zipper closure.

10. The limb-compression device of claim 1, in combination with a control unit that controls inflation and deflation of the bladders.

11. The combination of claim 10, wherein the control unit is configured to operate the limb-compression device differently, depending on whether the shell is folded at the foldable section.

12. The combination of claim 11, wherein the control unit receives input from the user as to whether the shell is folded at the foldable section.

13. The combination of claim 11, wherein the control unit automatically detects whether the shell is folded at the foldable section.

14. The combination of claim 10, wherein the control unit includes a compressor for supplying compressed air to the bladders.

15. The combination of claim 14, wherein the compressor is a battery-powered compressor.

16. The combination of claim 10, further in combination with:
an additional limb-compression device; and
a manifold couplable to the control unit and the limb-compression devices.

17. A control unit for controlling inflation and deflation of bladders in a shell of a limb-compression device, the control unit comprising:
circuitry configured to operate the limb-compression device differently, depending on whether the shell is folded at a foldable section.

18. A method of configuring a limb-compression device, the method comprising:
providing the limb-compression device, the leg-compression device including:
a shell for receiving a limb of a user therein; and
multiple compression bladders within the shell, spaced along a length of the shell;
wherein the shell includes a foldable section between an adjacent pair of the bladders, to allow folding of the shell to reduce a length of the limb-compression device to less than the length of the shell; and
selecting the length of the limb-compression device based limb leg length of the user, if necessary, folding the shell at the foldable section to reduce the length of the limb-compression device.

19. The method of claim 18, further comprising configuring a control unit that is coupled to the limb-compression device, based on whether the shell is folded at the foldable section.

20. The method of claim 19, wherein the control unit is configured automatically based on whether the shell is folded at the foldable section.
